(19) United States
(12) Patent Application Publication
(10) Pub. No.: US 2026/0264137 A1
(43) Pub. Date: Sep. 10, 2026

(54) METHOD FOR PRODUCING A PLURALITY OF TURBINE ENGINE BLADES

(71) Applicants: SAFRAN, PARIS (FR); SAFRAN AIRCRAFT ENGINES, PARIS (FR)

(72) Inventors: Nicolas Romain Benjamin LERICHE, MOISSY-CRAMAYEL (FR); Morgan MERRIEN, MOISSY-CRAMAYEL (FR); Etienne Benjamin BAUDRY, MOISSY-CRAMAYEL (FR); Besnik SADRIJI, MOISSY-CRAMAYEL (FR); Julio-Alejandro AGUILAR ORTIZ, MOISSY-CRAMAYEL (FR); Assia BOUDRA, MOISSY-CRAMAYEL (FR)

(21) Appl. No.: 18/876,305

(22) PCT Filed: Jun. 19, 2023
(86) PCT No.: PCT/FR2023/050903

§ 371 Date: Dec. 18, 2024

(30) Foreign Application Priority Data
Jun. 22, 2022 (FR) FR2206197

(51) Int. Cl. B22D 13/02; F01D 5/14

(52) U.S. Cl. CPC B22D 13/026; F01D 5/141; F05D 2230/20; F05D 2300/17

(57) ABSTRACT

A method for producing a plurality of blades having a first height includes providing a mold having an internal cavity bounded by an internal side face of the mold which is axisymmetric about a longitudinal axis, the side face extending along the longitudinal axis to a second height which is greater than or equal to first height, the side face defining a plurality of sections perpendicular to the longitudinal axis, which have a radius for each section. The ratio of the height of the side face to the radius of the section is less than or equal to 2.0. The method also includes rotating the mold about the longitudinal axis at a rotation speed of between 200 rpm and 800 rpm, and pouring a material into the internal cavity in order to form, by centrifugation, a tubular part along the longitudinal axis.

### TECHNICAL FIELD

This description relates to a method for producing a plurality of turbine engine blades.

### PRIOR ART

To manufacture turbine engine blades, it is known to first produce a tubular part 20 (also called a “barrel”) and to machine into it the blanks of turbine engine blades 10, or the turbine engine blades 10 directly. As can be seen in FIG. 1a, tubular part 20 extends along a first axis A1 between a first end and a second end and has a thickness in the radial direction. Blades 10 may thus be machined in the thickness of tubular part 20 by being arranged circumferentially one after the other around first axis A1. Thus, as can be seen in FIG. 1b, each blade 10 extends substantially parallel to first axis A1.

Ideally, as shown in FIG. 2, the radially internal face 24 of tubular part 20 has, in a section plane comprising first axis A1, a straight profile 25 which is aligned with first axis A1. However, tubular part 20 is generally obtained by vertical centrifugal casting which gives a parabolic profile to internal face 24 of tubular part 20. Thus, tubular part 20 has a thickness e₁ which is greater at the first end than the thickness e₂ at the second end. Tubular part 20 therefore comprises a non-functional portion 22, or excess material, at the first end which does not participate in the creation of the blades. Non-functional portion 22 is therefore eliminated during the manufacture of blades 10, which reduces the yield of the production method.

### SUMMARY

A method for producing a plurality of turbine engine blades having a height is provided, the method comprising:
providing a mold comprising an internal cavity, the internal cavity being bounded by an internal side face of the mold which is axisymmetric about a longitudinal axis, the side face extending along the longitudinal axis to a height which is greater than or equal to the height of each blade, the side face defining a plurality of sections which are perpendicular to the longitudinal axis, each section of the side face having a radius, the side face of the mold being such that, for each section, the ratio of the height of the side face to the radius of the section is less than or equal to 2.0;
positioning the mold so that the longitudinal axis is aligned with the gravity field,
rotating the mold about the longitudinal axis at a rotation speed comprised between 200 rpm and 800 rpm,
pouring a material into the internal cavity of the mold so as to form, by centrifugation, a tubular part extending along the longitudinal axis.

The obtained tubular part extends longitudinally between a lower end and an upper end to a height that is coincident with the height of the side face of the mold. Furthermore, the tubular part has an external face that is coincident with the side face of the mold. The external face of the tubular part is axisymmetric about the longitudinal axis. The tubular part defines a plurality of sections that are perpendicular to the longitudinal axis. Each section of the tubular part is associated with a corresponding section of the side face of the mold that is located at the same longitudinal position. Each section of the tubular part has an outer radius that is coincident with the radius of the corresponding section of the side face of the mold.

Furthermore, the tubular part thus obtained has an internal face which substantially has the shape of a truncated cone about the longitudinal axis. In other words, the profile of the internal face of the tubular part, in a section plane comprising the longitudinal axis, is substantially a straight line segment forming an angle with the longitudinal axis. Such a profile of the internal face of the tubular part makes it possible to reduce, or even eliminate, the amount of material forming a non-functional portion of the tubular part. The method therefore allows reducing the initial amount of material required to obtain the plurality of blades. In other words, the method improves the casting yield in the manufacturing of the plurality of turbine engine blades.

The term “functional” used in reference to portions of the tubular part allows indicating whether the portion thus described is used in creating one or more blades. Thus, a functional portion of the tubular part is a portion that contains blades with limited excess thickness in their material (such excess thickness is on the order of a millimeter, preferably less than 10 mm, more preferably less than 5 mm). The functional portion of the tubular part may have a profile in a section plane comprising the longitudinal axis that has the shape of a parallelogram, of which one of the sides is coincident with the external face of the tubular part. In one particular embodiment, the functional portion of the tubular part has a rectangular profile in a section plane comprising the longitudinal axis. Conversely, the non-functional portion is a portion that does not participate in the creation the blades. Therefore, the amount of material forming the non-functional portion is lost during the manufacture of the blades. The non-functional portion may be located radially internally relative to the functional portion.

The side face of the mold may be such that, for each section, the ratio of the height of the side face to the radius of the section is between 0.5 and 1.5, preferably between 0.75 and 1.25, more preferably is equal to 1.0.

The height of the side face of the mold may be between 150 mm and 2000 mm.

Each section of the side face of the mold extends in a plane perpendicular to the longitudinal axis. Each section has a circular shape centered on the longitudinal axis.

The radius of each section of the side face of the mold may be defined as the distance separating the side face from the longitudinal axis in the plane perpendicular to the corresponding longitudinal axis of the section. The side face may comprise at least two sections having radii which are different from each other. The radius of each section of the side face may be determined as a function of the longitudinal position of the section on the side face, for example according to a linear law. Alternatively, the radius of each section of the side face may be identical.

The radius of each section of the side face of the mold may be between 150 mm and 1500 mm.

Each section of the tubular part extends in a plane perpendicular to the longitudinal axis.

The external face of the tubular part may have, in each section of the tubular part, a circular shape centered on the longitudinal axis.

The outer radius of each section of the tubular part may be defined as the distance separating the external face of the tubular part from the longitudinal axis in the plane perpendicular to the corresponding longitudinal axis of the section. The tubular part may comprise at least two sections having outer radii which are different from each other. The outer radius of each section of the tubular part may be determined as a function of the longitudinal position of the section on the tubular part, for example according to a linear law. Alternatively, the outer radius of each section of the tubular part may be identical.

The internal face of the tubular part may have, in each section of the tubular part, a circular shape centered on the longitudinal axis.

Each section of the tubular part may have an inner radius. The inner radius of each section of the tubular part may be defined as the distance separating the internal face of the tubular part from the longitudinal axis in the plane perpendicular to the corresponding longitudinal axis of the section. The inner radius of each section of the tubular part may be determined as a function of the longitudinal position of the section on the tubular part, for example according to a linear law.

The internal face of the tubular part [may have the shape of a truncated cone with a half-angle at the apex defined by γ=g/(ω²(Re₀−eₜ)) where
g is the gravitational acceleration;
ω is the rotation speed of the mold about the longitudinal axis;
Re₀ is the outer radius of the section of the tubular part located at the lower end of the tubular part;
eₜ is a theoretical thickness which satisfies (eₜ/(Re₀−eₜ)≤0.7.

The mold may comprise at least one tubular wall extending along the longitudinal axis. The tubular wall may comprise the side face. The tubular wall of the mold may extend along the longitudinal axis between a lower end and an upper end.

The tubular part obtained may have a plurality of sections perpendicular to the longitudinal axis, the method further comprising: determining an amount of material to be poured into the mold so that each section of the tubular part has a thickness that is greater than or equal to a theoretical thickness eₜ which satisfies (eₜ/(Re₀−eₜ)≤0.7 where Re₀ is the outer radius of the section of the tubular part that is located at a lower end of the tubular part. This makes it possible to ensure that the tubular part is sufficiently thick for producing a turbine engine blade regardless of the longitudinal position concerned on the tubular part; in other words, the minimum theoretical thickness for producing a turbine engine blade regardless of the longitudinal position concerned on the tubular part.

The thickness of each section of the tubular part may be considered in a radial direction relative to the longitudinal axis. The thickness of each section of the tubular part may be defined as the difference between the outer radius and the inner radius of the section.

The tubular part may comprise at least two sections having thicknesses which are different from each other. Alternatively, the thickness of each section of the tubular part may be identical.

In particular, the thickness of the section of the tubular part which is located at the upper end of the tubular part may be greater than or equal to a theoretical thickness which satisfies (eₜ/(Re₀−eₜ))≤0.7 where Re₀ is the outer radius of the section of the tubular part which is located at the lower end of the tubular part.

The functional portion of the tubular part may have, for each section of the tubular part, a thickness in a radial direction relative to the longitudinal axis. The thickness of the functional portion may be greater than or equal to the theoretical thickness for each section of the tubular part.

The internal cavity of the mold may be bounded by an internal lower face of the mold and an internal upper face of the mold, the lower face and the upper face respectively being connected to a lower end and an upper end of the side face, the lower face and the upper face preferably each being perpendicular to the longitudinal axis.

The lower face and/or the upper face of the mold may each be axisymmetrical about the longitudinal axis.

The mold may comprise a lower wall and an upper wall each extending transversely to the longitudinal axis. The upper wall and the lower wall may be respectively connected to a lower end and an upper end of the tubular wall of the mold. The lower wall and the upper wall may respectively comprise the inner lower face and the inner upper face. The upper wall may comprise an opening for pouring material into the inner cavity. The lower wall may be without any openings.

The side face of the mold may be generally a cylinder of revolution about the longitudinal axis. The rotation speed of the mold about the longitudinal axis may be comprised between 600 rpm and 800 rpm. Such a method allows obtaining a tubular part in which the mass of the non-functional portion is less than or equal to 5% relative to the mass of the functional portion of the tubular part.

The side face of the mold may have the general shape of a truncated cone, of revolution about the longitudinal axis, with a cross-section which decreases in the direction of the gravity field when the mold is positioned with the longitudinal axis aligned with the gravity field. The rotation speed of the mold about the longitudinal axis may be comprised between 200 rpm and 400 rpm, preferably between 300 rpm and 400 rpm. Such a method allows obtaining a tubular part in which the mass of the non-functional portion is less than or equal to 5% relative to the mass of the functional portion. In addition, such a method advantageously has a low rotation speed for the mold, which allows reducing the power required to rotate the mold about the longitudinal axis and therefore the energy consumption of the method. Also, this makes it possible to avoid certain problems inherent in high rotation speeds, such as vibrations, rotating unbalance, or the rotation speed limit of the mold.

The side face of the mold has the shape of a truncated cone with a half-angle at the apex defined by β=g/(ω²(Re₀−eₜ)) where
g is the gravitational acceleration;
ω is the rotation speed of the mold about the longitudinal axis;
Re₀ is the outer radius of a section of the tubular part which is perpendicular to the longitudinal axis and which is located at a lower end of the tubular part;
eₜ is a theoretical thickness which satisfies (eₜ/(Re₀−eₜ))≤0.7.

The half-angle at the apex of the side face of the mold is thus equal to the half-angle at the apex of the internal face of the tubular part. The thickness of each section of the tubular part is thus identical, regardless of the longitudinal position of the section on the tubular part. This allows further reducing, or even eliminating, the amount of material that forms a non-functional portion of the tubular part.

The side face of the mold may comprise at least one relief formed annularly around the longitudinal axis. Such an annular relief allows partially pre-forming the turbine engine blades in the annular part.

The annular relief may be an annular groove formed in the side face of the mold. The annular relief may project radially from the side face of the mold.

The material poured in the mold may be a metal alloy, preferably titanium aluminide (TiAl), more preferably a γ-TiAl alloy. Titanium aluminide advantageously has good mechanical strength at high temperatures and a low density.

The material poured into the mold may be a γ-TiAl alloy and the method may further comprise heating the material to a temperature between 1550° C. and 1700° C. in order to be poured into the mold. The material poured in the mold may be molten.

The method may further comprise machining the tubular part in order to create the plurality of turbine engine blades.

### BRIEF DESCRIPTION OF DRAWINGS

Other features, details and advantages will become apparent upon reading the detailed description below, and upon analysis of the appended drawings, in which:

FIG. 1 schematically represents a perspective view of different steps of a known method for producing a plurality of blades;

FIG. 2 schematically represents a section view of a tubular part used in the method of FIG. 1;

FIG. 3 is a functional diagram of a method for producing turbine engine blades according to the present description;

FIG. 4 schematically represents a perspective view of a mold used in the method of FIG. 3 according to a first embodiment;

FIG. 5 schematically represents a section view of the mold of FIG. 4, in section plane IV-IV;

FIG. 6 schematically represents a section view of the mold of FIG. 4, in section plane V-V;

FIG. 7 schematically represents a perspective view of a mold used in the method of FIG. 3 according to a second embodiment;

FIG. 8 schematically represents a section view of the mold of FIG. 7, in section plane VII-VII;

FIG. 9 schematically represents a variant of the mold according to the first embodiment of FIG. 4;

FIG. 10 schematically represents a variant of the mold according to the second embodiment of FIG. 7.

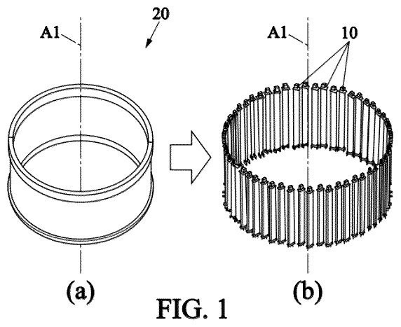

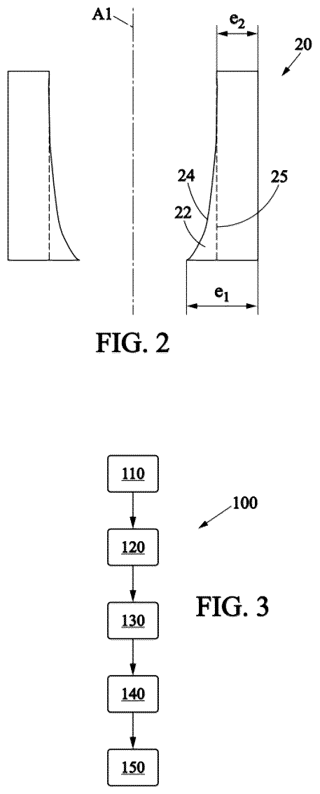

### DESCRIPTION OF EMBODIMENTS

Reference is now made to FIG. 3. FIG. 3 is a functional diagram of a method 100 for producing a plurality of turbine engine blades 10. Each blade 10 is intended to extend between a root and a tip (or heel) to a height Ha.

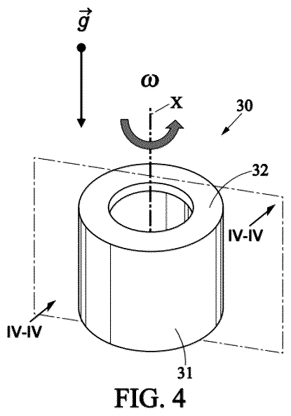

Production method 100 comprises a first step 110. First step 110 comprises providing a mold 30. Reference is first made to FIGS. 4 to 6 which show a first embodiment of mold 30.

Mold 30 firstly comprises a tubular wall 31 extending along a longitudinal axis X. In the following, orientation qualifiers such as “longitudinal”, “radial”, or “circumferential”, are defined with reference to longitudinal axis X. Tubular wall 31 of mold 30 extends along longitudinal axis X between a lower end and an upper end. Mold 30 also comprises a lower wall 33 and an upper wall 32 each extending transversely to longitudinal axis X. Upper wall 32 and lower wall 33 are respectively connected to the upper end and the lower end of tubular wall 31 of mold 30. Upper wall 32 and lower wall 33 extend radially inward from tubular wall 31. In the example shown, upper wall 32 and lower wall 33 each extend perpendicularly to longitudinal axis X.

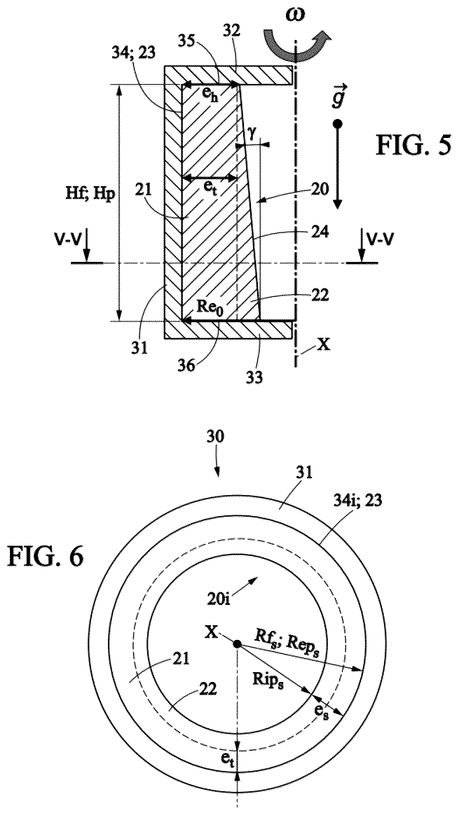

Mold 30 further comprises an internal cavity. The internal cavity is bounded by an internal side face 34 of mold 30. Side face 34 is formed by tubular wall 31. In other words, side face 34 is an internal face of tubular wall 31 of mold 30. Side face 34 is more particularly visible in FIGS. 5 and 6. Internal side face 34 of mold 30 is axisymmetric about a longitudinal axis X. Side face 34 extends along longitudinal axis X to a height Hf which is greater than height Ha of each blade 10. Height Hf of side face 34 of mold 30 is between 150 mm and 2000 mm.

Side face 34 defines a plurality of sections 34i which are perpendicular to longitudinal axis X. FIG. 6 shows one of sections 34i of side face 34. Each section 34i of side face 34 of mold 30 extends in a plane perpendicular to longitudinal axis X. Each section 34i therefore has a circular shape centered on longitudinal axis X. Each section 34i of side face 34 has a radius Rfₛ. Radius Rfₛ of each section 34i of side face 34 of mold 30 is defined as being the distance separating side face 34 from longitudinal axis X in the plane perpendicular to the corresponding longitudinal axis X of section 34i. Radius Rfₛ of each section 34i of side face 34 of mold 30 is between 150 mm and 1500 mm.

It is noteworthy that, according to the first embodiment, side face 34 of mold 30 is generally a cylinder of revolution about longitudinal axis X. In other words, radius Rfₛ of each section 34i of side face 34 is identical.

Side face 34 of mold 30 is such that, for each section 34i, the ratio of height Hf of side face 34 to radius Rfₛ of section 34i is less than or equal to 2.0. Side face 34 of mold 30 may be such that, for each section 34i, the ratio of height Hf of side face 34 to radius Rfₛ of section 34i is between 0.5 and 1.5, preferably between 0.75 and 1.25, more preferably is equal to 1.0.

The internal cavity of mold 30 is further bounded by an internal lower face 36 of mold 30 and an internal upper face 35 of mold 30. Lower face 36 and upper face 35 are formed respectively by lower wall 33 and upper wall 32. In other words, lower face 36 and upper face 35 are respectively an internal face of lower wall 33 and upper wall 32. Lower face 36 and upper face 35 are respectively connected to a lower end and an upper end of side face 34. In the illustrated example, lower face 36 and upper face 35 are preferably each perpendicular to longitudinal axis X. Also, here lower face 36 and upper face 35 of mold 30 are axisymmetric about longitudinal axis X.

Production method 100 comprises a second step 120. Second step 120 comprises positioning mold 30 so that longitudinal axis X is aligned with the gravity field g. Mold 30 is therefore positioned with longitudinal axis X extending vertically.

Production method 100 comprises a third step 130. Third step 130 comprises rotating mold 30 about longitudinal axis X at a rotation speed w comprised between 200 rpm and 800 rpm.

Production method 100 comprises a fourth step 140. Fourth step 140 comprises pouring a material into the internal cavity of mold 30 so as to form, by centrifugation, a tubular part 20 extending along longitudinal axis X. Obtained tubular part 20 is also visible in FIGS. 5 and 6.

Tubular part 20 extends longitudinally between a lower end and an upper end to a height Hp which is coincident with height Hf of side face 34 of mold 30. Furthermore, tubular part 20 has an external face 23 which is coincident with side face 34 of mold 30. External face 23 of tubular part 20 is axisymmetric about longitudinal axis X.

Tubular part 20 defines a plurality of sections 20i which are perpendicular to longitudinal axis X. Each section 20i of tubular part 20 extends in a plane perpendicular to longitudinal axis X. Each section 20i of tubular part 20 is associated with a corresponding section 34i of side face 34 of mold 30 which is located at the same longitudinal position. External face 23 of tubular part 20 therefore has, in each section 20i of tubular part 20, a circular shape centered on longitudinal axis X. In other words, each section 20i of tubular part 20 has an outer radius Reps which is coincident with radius Rfₛ of the corresponding section 34i of side face 34 of mold 30. Outer radius Reps of each section 20i of tubular part 20 is defined as being the distance separating external face 23 of tubular part 20 from longitudinal axis X in the plane perpendicular to the corresponding longitudinal axis X of section 20i. According to the first embodiment, outer radius Reps of each section 20i of tubular part 20 is identical.

In addition, due to the rotation speed w of mold 30 about longitudinal axis X and the predetermined ratio of height Hf of side face 34 to radius Rfₛ of each section 34i, tubular part 20 has an internal face 24 which substantially has the shape of a truncated cone about longitudinal axis X. Internal face 24 of tubular part 20 therefore has, in each section 20i of tubular part 20, a circular shape centered on longitudinal axis X. Each section 20i of tubular part 20 has an inner radius Ripₛ. Inner radius Ripₛ of each section 20i of tubular part 20 can be defined as being the distance separating internal face 24 of tubular part 20 from longitudinal axis X in the plane perpendicular to the corresponding longitudinal axis X of section 20i.

Internal face 24 of tubular part 20 has the shape of a truncated cone with a half-angle at the apex defined by γ=g/(ω²(Re₀−eₜ)) where
g is the gravitational acceleration;
w is the rotation speed of mold 30 about longitudinal axis X;
Re₀ is the outer radius of section 20i of tubular part 20 located at the lower end of tubular part 20;
eₜ is a theoretical thickness which satisfies (eₜ/(Re₀−eₜ))≤0.7.

In other words, as can be seen in FIG. 5, the profile of internal face 24 of tubular part 20 in a section plane comprising longitudinal axis X is a straight line segment forming an angle with longitudinal axis X that is equal to half-angle γ.

Inner radius Ripₛ for each section 20i evolves linearly along longitudinal axis X, according to the relation Ripₛ(z)=Ripₛ(0)+tan(γ)*z where
Ripₛ (z) is the inner radius of a given section 20i;
Ripₛ (0) is the inner radius of section 20i of tubular part 20 located at the lower end of tubular part 20;
z is the height of the given section 20i in tubular part 20.

Inner radius Ripₛ for each section 20i may evolve linearly along longitudinal axis X according to the relation Ripₛ(z)=Ripₛ(0)+γ*z.

The term “functional” used in reference to portions of tubular part 20 makes it possible to indicate whether the portion thus described is used in creating one or more blades 10. Thus, tubular part 20 comprises a functional portion 21 that contains blades 10 with limited excess thickness in their material (such excess thickness is on the order of a millimeter, preferably less than 10 mm, more preferably less than 5 mm). Functional portion 21 of tubular part 20 has a profile in a section plane comprising longitudinal axis X that has the shape of a rectangle, of which one of the sides is coincident with external face 23 of tubular part 20. Tubular part 20 comprises a non-functional portion 22 which does not participate in the creation of blades 10. Non-functional portion 22 is located radially internally relative to functional portion 21.

Such a profile of internal face 24 of tubular part 20 allows reducing or even eliminating the amount of material forming a non-functional portion 22 of tubular part 20. Method 100 therefore allows reducing the initial amount of material necessary in order to obtain the plurality of blades 10. In other words, method 100 improves the casting yield in the manufacturing of the plurality of turbine engine blades 10.

Fourth step 140 further comprises determining the amount of material to be poured into mold 30 so that each section 20i of tubular part 20 has a thickness eₛ which is greater than or equal to a theoretical thickness eₜ which satisfies (eₜ/(Re0−eₜ)≤0.7. This makes it possible to ensure that tubular part 20 is sufficiently thick for producing a turbine engine blade 10 regardless of the longitudinal position concerned on tubular part 20. Preferably, thickness eₛ of each section 20i of tubular part 20 is substantially equal to the theoretical thickness. Thickness eₛ of each section 20i of tubular part 20 is considered in a radial direction relative to longitudinal axis X. Thickness eₛ of each section 20i of tubular part 20 is defined as being the difference between outer radius Reps and inner radius Ripₛ of section 20i. According to the first embodiment, thickness eₛ of each section 20i of tubular part 20 is different from thickness eₛ of each other section 20i.

In particular, thickness eₕ of section 20i which is located at the upper end of tubular part 20 is equal to the theoretical thickness eₜ which satisfies (eₜ/(Re₀−eₜ))≤0.7 where Re₀ is the outer radius of the section 20i of tubular part 20 which is located at a lower end of tubular part 20.

Furthermore, functional portion 21 of tubular part 20 has, for each section 20i of tubular part 20, a thickness in a radial direction relative to longitudinal axis X. Here, the thickness of functional portion 21 is equal to the theoretical thickness eₜ for each section 20i of tubular part 20.

Advantageously, the rotation speed of mold 30 about longitudinal axis X is between 600 rpm and 800 rpm. It is thus possible to obtain a tubular part 20 in which the mass of non-functional portion 22 is less than or equal to 5% relative to the mass of functional portion 21 of tubular part 20.

The material poured into mold 30 is a metal alloy of the γ-TiAl type. Such a material advantageously has good mechanical resistance at high temperatures and a low density.

Fourth step 140 further comprises heating the material to a temperature between 1550° C. and 1700° C. in order to be poured into mold 30. The material poured into mold 30 is thus molten, which facilitates casting.

Method 100 comprises a fifth step 150. Fifth step 150 comprises the production of a plurality of turbine engine blades 10 in tubular part 20, in particular in functional portion 21 of tubular part 20. To do this, tubular part 20 may be machined. The machining may first comprise the elimination (if necessary) of non-functional portion 22. The machining may then comprise the creation of blades 10 in functional portion 21.

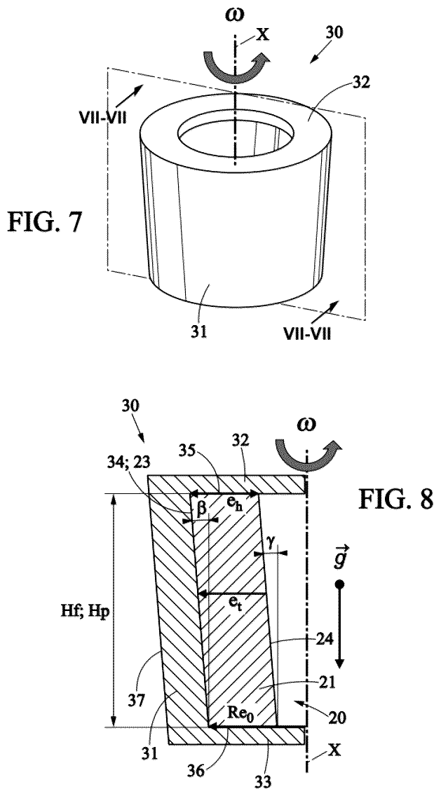

FIGS. 7 and 8 show the mold 30 used in method 100 as described above, according to a second embodiment. Mold 30 according to the second embodiment differs from mold 30 according to the first embodiment in that side face 34 of mold 30 has the general shape of a truncated cone, of revolution about longitudinal axis X, with a cross-section that decreases in the direction of the gravity field when mold 30 is positioned with longitudinal axis X aligned with the gravity field.

Thus, radius Rfₛ of each section 34i of side face 34 is different from radius Rfₛ of each other section 34i of side face 34. In particular, radius Rfₛ for each section 34i of side face 34 decreases linearly along longitudinal axis X in the direction of the gravity field.

Here too, external face 23 of tubular part 20 is coincident with side face 34 of mold 30. External face 23 of the tubular part therefore has the general shape of a truncated cone, of revolution about longitudinal axis X, with a cross-section that decreases in the direction of the gravity field when mold 30 is positioned with longitudinal axis X aligned with the gravity field. Therefore, outer radius Reps of each section 20i of tubular part 20 is different from outer radius Reps of each other section 20i of tubular part 20. In particular, outer radius Reps for each section 20i of tubular part 20 decreases linearly along longitudinal axis X in the direction of the gravity field.

Advantageously, here the rotation speed of mold 30 about longitudinal axis X according to the second embodiment is between 200 rpm and 400 rpm, preferably between 300 rpm and 400 rpm. Such a method 100 makes it possible to obtain a tubular part 20 in which the mass of non-functional portion 22 is less than or equal to 5% relative to the mass of functional portion 21. In addition, such a method 100 advantageously has a low rotation speed of mold 30, which allows reducing the power required to rotate mold 30 about longitudinal axis X and therefore the energy consumption of method 100.

In addition, side face 34 of mold 30 has the shape of a truncated cone with a half-angle at the apex defined by β=g/(ω² (Re₀−eₜ)) where
g is the gravitational acceleration;
ω is the rotation speed of mold 30 about longitudinal axis X;
Re₀ is the outer radius of section 20i located at the lower end of tubular part 20; and
eₜ is a theoretical thickness which satisfies (eₜ/(Re₀−eₜ))≤0.7.

Half-angle β at the apex of side face 34 of mold 30 is thus equal to half-angle γ at the apex of internal face 24 of tubular part 20. Thickness eₛ of each section 20i of tubular part is thus identical, regardless of the longitudinal position of the section in tubular part 20. The tubular part therefore has a constant radial thickness over its entire height Hf. In the present case, this allows eliminating non-functional portion 22 of tubular part 20. In other words, the use of the mold according to the second embodiment allows obtaining a tubular part 20 that is without any non-functional portion 22. In this case, for each section, thickness eₛ of tubular part 20 is equal to the thickness of functional portion 21, i.e. in the present case to theoretical thickness eₜ.

Also noteworthy is that functional portion 21 of tubular part 20 has, in the second embodiment, a profile in a section plane comprising longitudinal axis X which has the shape of a parallelogram, of which one of the sides is coincident with external face 23 of tubular part 20.

Tubular wall 31 of the mold also comprises an external face 37. External face 37 of tubular wall 31 advantageously has the shape of a truncated cone. In particular, according to the example shown, here external face 37 of tubular wall 31 has the shape of a truncated cone in which the half-angle at the apex is equal to the half-angle at the apex β of side face 34. This makes it possible to obtain constant heat extraction over the entire height of the mold.

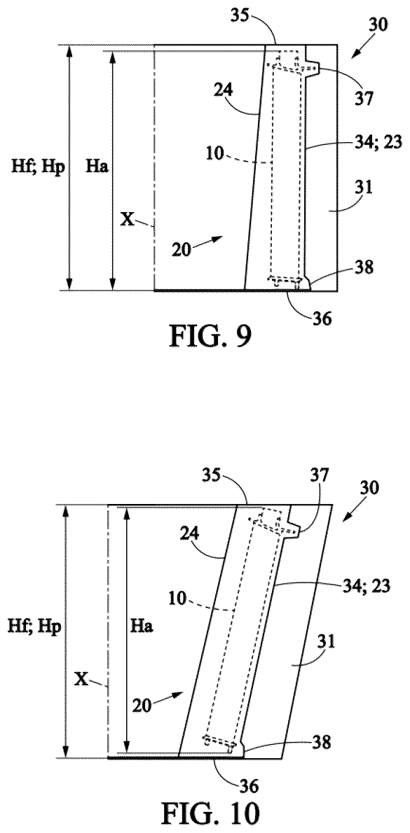

FIGS. 9 and 10 respectively represent a variant of mold 30 according to the first embodiment and of mold 30 according to the second embodiment. In each of these variants, side face 34 of mold 30 comprises a first relief and a second relief each formed annularly around longitudinal axis X. Such annular reliefs make it possible to partially preform the turbine engine blades 10 in the annular part. Here, first annular relief 38 and the second relief are each an annular groove formed in side face 34 of mold 30. First annular relief 38 is located near the lower end of side face 34. Second annular relief 37 is located near the upper end of side face 34. Here, first annular relief 38 is intended for pre-forming the root of each blade 10, and second annular relief 37 is intended for pre-forming the tip of each blade 10.

1. A method (100) for producing a plurality of turbine engine blades (10) having a height (Ha), the method comprising:
providing a mold (30) comprising an internal cavity, the internal cavity being bounded by an internal side face (34) of the mold which is axisymmetric about a longitudinal axis (X), the side face (34) extending along the longitudinal axis (X) to a height (Hf) which is greater than or equal to the height (Ha) of each blade (10), the side face (34) defining a plurality of sections (34i) which are perpendicular to the longitudinal axis (X), each section (34i) of the side face (34) having a radius (Rfs), the side face (34) of the mold (30) being such that, for each section (34i), the ratio of the height (Hf) of the side face (34) to the radius (Rfₛ) of the section (34i) is less than or equal to equal to 2.0;
positioning the mold (30) so that the longitudinal axis (X) is aligned with the gravity field (g),
rotating the mold (30) about the longitudinal axis (X) at a rotation speed (ω) comprised between 200 rpm and 800 rpm,
pouring a material into the internal cavity of the mold (30) so as to form, by centrifugation, a tubular part (20) extending along the longitudinal axis (X).

2. The method according to claim 1, wherein the tubular part (20) has a plurality of sections (20i) that are perpendicular to the longitudinal axis (X), the method further comprising:
determining an amount of material to be poured into the mold (30) so that each section (20i) of the tubular part (20) has a thickness (es) that is greater than or equal to a theoretical thickness (eₜ) which satisfies (eₜ/(Re₀−eₜ))≤0.7 where Re₀ is the outer radius of the section of the tubular part (20) which is located at a lower end of the tubular part (20).

3. The method according to claim 1, wherein the internal cavity of the mold (30) is bounded by an internal lower face (36) of the mold (30) and an internal upper face (35) of the mold, the lower face (36) and the upper face (35) respectively being connected to a lower end and an upper end of the side face (34), the lower face (36) and the upper face (35) preferably each being perpendicular to the longitudinal axis (X).

4. The method according to claim 1, wherein the side face (34) of the mold (30) is generally a cylinder of revolution about the longitudinal axis (X), and wherein the rotation speed (ω) of the mold (30) about the longitudinal axis (X) is comprised between 600 rpm and 800 rpm.

5. The method according to claim 1, wherein the side face (34) of the mold (30) has the general shape of a truncated cone, of revolution about the longitudinal axis (X), with a cross-section which decreases in the direction of the gravity field (g) when the mold (30) is positioned with the longitudinal axis (X) aligned with the gravity field (g), and wherein the rotation speed (ω) of the mold (30) about the longitudinal axis (X) is comprised between 200 rpm and 400 rpm.

6. The method according to claim 1, wherein the side face (34) of the mold (30) has the shape of a truncated cone with a half-angle (β) at the apex defined by β=g/(ω²(Re₀−eₜ)) where
g is the gravitational acceleration;
ω is the rotation speed of the mold about the longitudinal axis;
Re₀ is the outer radius of a section of the tubular part which is perpendicular to the longitudinal axis and which is located at a lower end of the tubular part;
eₜ is a theoretical thickness which satisfies eₜ/(Re₀−eₜ))≤0.7.

7. The method according to claim 1, wherein the side face (34) of the mold (30) comprises at least one relief (37; 38) formed annularly around the longitudinal axis (X).

8. The method according to claim 1, wherein the material poured into the mold (30) is a metal alloy.

9. The method according to claim 1, wherein the material poured into the mold (30) is an alloy of the γ-TiAl type, the method further comprising heating the material to a temperature between 1550° C. and 1700° C. in order to be poured into the mold (30).

10. The method of claim 1, the method further comprising the machining of the tubular part (20) in order to create the plurality of turbine engine blades (10).

11. The method according to claim 8, wherein the metal alloy is titanium aluminide (TiAl).

12. The method according to claim 11, wherein the metal alloy is a γ-TiAl alloy.
